(19) United States
(12) Patent Application Publication
(10) Pub. No.: US 2026/0209007 A1
(43) Pub. Date: Jul. 23, 2026

(54) A LIFTING YOKE AND A METHOD FOR PLACING AND POSITIONING ITEMS ON AN INNER SURFACE OF A SHELL HALF OF A WIND TURBINE BLADE

(71) Applicant: ALVAC INDUSTRY A/S, Holstebro (DK)

(72) Inventors: Jens Skov RUDBECK, Mejrup, Holstebro (DK); Ole Mogensen, Mejrup, Holstebro (DK)

(21) Appl. No.: 19/144,533

(22) PCT Filed: Jan. 2, 2024
(86) PCT No.: PCT/DK2024/050001

§ 371 Date: Jun. 30, 2025

(30) Foreign Application Priority Data
Jan. 3, 2023 (DK) PA202370002

(51) Int. Cl. B66C 1/10; B32B 37/12; B32B 38/18; F03D 13/10

(52) U.S. Cl. CPC B66C 1/108; B32B 38/1808; F03D 13/10; B32B 37/12; B32B 2603/00; F05B 2230/60

(57) ABSTRACT

A lifting yoke for placing and positioning items on an inner surface of a shell half of a wind turbine blade is provided. The lifting yoke includes—a longitudinal beam, —a plurality of landing pads positioned along the longitudinal beam configured for standing on the inner surface of the shell half. Also included is: —a plurality of global adjustment arrangements for pivoting the plurality of landing pads, wherein the landing pads include—a contact surface for being in contact with the inner surface, and —a local adjustment arrangement for adjusting a curvature of the contact surface to the curvature of the inner surface.

### CROSS REFERENCE TO RELATED APPLICATIONS

This application is a national stage of PCT Application No. PCT/DK2024/050001, having a filing date of Jan. 2, 2024, which is based on DK Application No. PA 2023 70002, having a filing date of Jan. 3, 2023, the entire contents both of which are hereby incorporated by reference.

### FIELD OF TECHNOLOGY

The following relates to a lifting yoke and a method for placing and positioning item on an inner surface of a shell half of a wind turbine blade.

### BACKGROUND

Wind turbines are being installed across the globe at a rapid rate as part of the green transition, and at the same time the rotor diameter and thus the wind turbine blade length is growing rapidly to capture more wind and produce more electricity. Thus, optimization of the wind turbine production, especially production of the wind turbine blades themselves, becomes increasingly relevant, as production time need to be reduced and space at the production site becomes limited.

Present day wind turbine blades typically comprise a hollow shell which is made of two shell halves. Additionally, reinforcing elements such as shear webs are often installed inside the blade shell to increase stiffness, compressive strength, and limit distortion of the blade structure from shear forces. The production methods typically utilise a shell mould, where the first and second shell halves are formed in first and second half-moulds, respectively. After the shell halves have been moulded, a reinforcing element is often installed and bonded on the inner surface of the first shell half. During this process, the shear webs must be supported while being arranged and bonded, since misalignment of the shear webs relative to the blade shell can be both difficult and costly to rectify. Once the shear webs have been installed in the first shell half, the second shell half is positioned on top of the first shell half and the inner surface of the second shell half is bonded to the shear webs to form a complete blade shell.

WO 2021190973 A1 relates to a method for arranging shear webs within a first shell half, utilising a support frame that is fixed on the inside of the first shell half. Guide elements fastened to the shear webs engage with the support frame upon lowering the shear webs into the first shell half, thereby supporting the shear webs during arrangement and bonding. A disadvantage of this method is that it is very time consuming, as the support frame needs to be installed within the first shell half before arranging the shear web withing the first shell half and then needs to be removed after joining the first and second shell halves.

WO 2022223576 A1 relates to a method and a lifting assembly for arranging shear webs in a first shell half. The lifting assembly comprises a crane device, a lifting rail, and a plurality of lifting clamps. The lifting clamps are attached to the shear webs which are lifted into the first shell half and held in position by the lifting assembly while bonding to the first shall half. This method has the disadvantage of being time consuming, as the lifting assembly needs to hold the shear web during the bonding process, which prevents further work on the blade shell. Furthermore, this method and lifting assembly requires a lot of space during shear web installation, as the crane is needed throughout the entire installation process.

DE202012006650 U1 relates to an apparatus for handling shear webs. The apparatus is configured for holding one or two shear webs and selectively press the shear webs into an adhesive bed on the inner surface of a first shell half. A disadvantage of this apparatus is that the process of installing the shear webs becomes time consuming, since the apparatus needs to hold the shear web during the bonding process, which prevents further work on the blade shell. Furthermore, this apparatus requires a lot of space during shear web installation, as a crane is needed to lift the apparatus throughout the entire installation process.

WO2013023745 A1 relates to a method for mounting shear webs in a first shell half. Two shear webs are connected to a plurality of cross-connecting devices and lifted into the first shell half with a positioning device and glued to the shell. Once the glue is cured, the position device is removed, and the second shell half is positioned on top of the first shell half. Once the blade shell is closed, the cross-connecting devices accessible to human workers can be removed. This is disadvantageous, as it is very time consuming to install the cross-connection devices before lifting the shear webs into the first shell half. Furthermore, only some of the cross-connection devices can be removed after the blade shell has been assembled, thereby adding additional weight to the wind turbine blade. This is a great disadvantage in further handling of the wind turbine blade and for the productivity of the finished wind turbine.

Besides placing reinforcement elements in the blade shell, there may also be a need for providing tools to the inner surface of the first and second shell halves for performing a variety of different tasks such as placement of a lightning protection system (LPS) on the inside of the blade shell.

There is a need in the art for a lifting apparatus and a method for placing and positioning items, such as shear webs, on or providing tools to an inner surface of a shell half of a wind turbine blade, that optimizes the production time, the production process of a wind turbine blade, and saves space at the production site, to allow for more and increasingly large wind turbine blades to be produced.

### SUMMARY

An aspect relates to a lifting yoke and a method for placing and positioning items on an inner surface of a shell half of wind turbine blade.

An aspect of embodiments of the invention is achieved by a lifting yoke for placing and positioning items on an inner surface of a shell half of a wind turbine blade. The lifting yoke comprises
a longitudinal beam,
a plurality of landing pads positioned along the longitudinal beam configured for standing on the inner surface of the shell half,
a plurality of global adjustment arrangements for pivoting the plurality of landing pads. The landing pads comprise
   a contact surface for being in contact with the inner surface,
   a local adjustment arrangement for adjusting a curvature of the contact surface to the curvature of the inner surface.

The lifting yoke is a lifting yoke for placing and positioning items on an inner surface of a shell half, where the items may be items to be mounted or tools for performing tasks on the inner surface. The lifting yoke is configured for standing on the inner surface of the shell half during the entire timespan of the task performed in the shell half, without needing to hold or support the lifting yoke with a lifting device. This makes the lifting yoke of embodiments of the present invention advantageous over conventional lifting apparatuses and methods, as the lifting device is available for other tasks while the lifting yoke is operating in the shell half, thereby freeing up and saving space at the production site.

An advantage of this is that more and increasingly large wind turbine blades can be produced at the production sites.

The items to be placed on the inner surface of the shell half may be shear webs or a lightning protection system or a gluing device or an abrading device. Structural elements such as shear webs are mounted and left in the shell half, and tools such as a gluing device or an abrading device are provided to the shell half and removed again after use.

The items to be lifted by the lifting yoke may be configured to attach onto the longitudinal beam of the lifting yoke and/or the longitudinal beam may be configured for holding the items.

In some embodiments, the lifting yoke may be lifted by a lifting device such as a crane or other solutions known by the skilled person.

The longitudinal beam may be positioned substantially parallel to the item to be lifted by the lifting yoke, thereby achieving a balanced and stable lift of the item.

The lifting yoke may further comprise an alignment pin positioned at each end of the longitudinal beam to ensure correct placement of the lifting yoke in the shell half.

The landing pads may be adaptable to fit the contour of the inner surface of the shell half, thereby ensuring that the lifting yoke is standing stable on the inner surface without breaking the shell half. An advantage of the landing pads being configured for standing on the inner surface of the shell half, is that the lifting yoke can stand on the inner surface without needing to hold or support the lifting yoke with a lifting device. The lifting device is thus available for other tasks while the lifting yoke is operating in the shell half, thereby freeing up and saving space at the production site.

An advantage of this is that the production time of the wind turbine blade is optimized and the need for multiple lifting devices at the production site is eliminated, which increases the amount of free space at the production site.

The plurality of landing pads positioned along the longitudinal beam may be evenly distributed along the bottom of the longitudinal beam to ensure that the lifting yoke is standing stable on the inner surface of the shell half.

In some embodiments, the bottom of the longitudinal beam may comprise a first side substantially parallel to a second side, where the plurality of landing pads is arranged alternatingly at the first and second side of the longitudinal beam. An advantage of this is that the lifting yoke stands more stable on the inner surface of the shell half and that the risk of the lifting yoke falling on its side is significantly reduced.

In other embodiments, the plurality of landing pads may be positioned in a straight line along the bottom of the longitudinal beam.

The global adjustment arrangements are configured for pivoting the landing pads relative to the contour of the inner surface of the shell half, thereby adjusting each landing pad individually to the local contour of the shell half.

An advantage of this is that the lifting yoke stands stable on the inner surface of the shell half without adding an unnatural pressure to the shell half, thus preventing breakage of the shell half.

The contact surface of the landing pad may be a flexible non-slip surface for securing the lifting yoke on the inner surface and ensuring that pressure load from the landing pad is evenly distributed over the contact surface, thus preventing the shell half from breaking.

In some embodiments, the contact surface may be a rubber membrane.

The local adjustment arrangement comprised in the landing pad may adjust the curvature of the contact surface by facilitating a bend of the contact surface upon contact with the inner surface of the shell half. Thereby adjusting the curvature of the contact surface to the curvature of the inner surface of the shell half.

An advantage of this is that each landing pad can be individually adjusted to the local curvature of the shell half.

Another advantage of this is that the pressure load from the landing pad is evenly distributed over the entire contact surface which prevents breakage of the shell half.

An advantage of the global adjustment arrangement and the local adjustment arrangement is that each landing pad can be adjusted to accommodate the contour and the curvature of the inner surface of the shell half, thereby preventing the shell half from breaking due to an unnatural pressure on the shell half.

In an aspect of the lifting yoke, the landing pads may be suction pads that are configured for gripping the inner surface of the shell half, thereby securing and stabilizing the lifting yoke in the shell half.

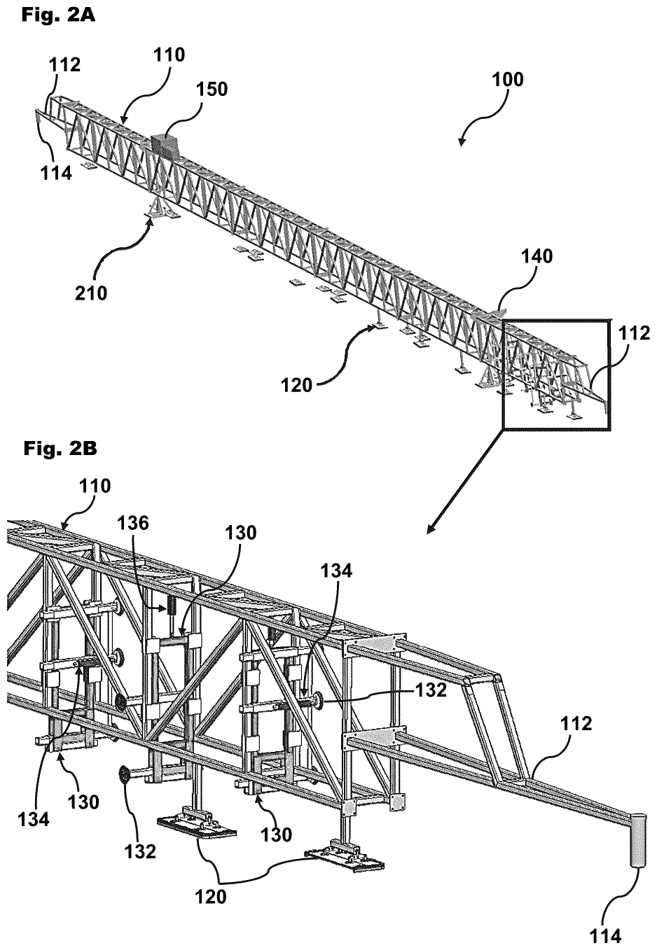

The landing pads may further be connected to one or more vacuum pumps for providing the vacuum at the landing pads. The one or more vacuum pumps may be positioned internally on the lifting yoke or externally from the lifting yoke. In the embodiment shown in FIG. 2A a vacuum pump for providing suction to the landing pads is positioned internally on the lifting yoke on top of the longitudinal beam.

An advantage of the one or more vacuum pumps, is that a continuous suction is provided at the landing pads, thereby ensuring a strong continuous adhesion to the inner surface of the shell half.

In an aspect of the lifting yoke, the global adjustment arrangement may comprise an arm defining a first rotation axis, where the arm is in pivotable connection with the landing pad around the first rotation axis. Thereby, pivoting the landing pad to fit the contour of the inner surface of the shell half.

An advantage of this is that each landing pad can be individually adjusted to the local contour of shell half, thereby ensuring that the lifting yoke stands stable on the inner surface without adding an unnatural pressure to the shell half, thus preventing breakage of the shell half.

In some embodiments, the arm may be a horizontal arm defining a first rotation axis that is substantially parallel to the longitudinal beam.

In an aspect of the lifting yoke, the local adjustment arrangement may comprise
two or more surface plates,
gaps positioned between the two or more surface plates, where the two or more surface plates are configured for bending the contact surface.

The two or more surface plates may comprise second rotation axes that are substantially parallel to the first rotation axis of the global adjustment system.

The two or more surface plates may be configured for pivoting around the second rotation axes, and the gaps positioned between the surface plates provide space for the surface plates to pivot relative to each other. Thereby, the local adjustment arrangement can adapt to the curvature of the inner surface of the shell half.

An advantage of this is that the local adjustment unit can facilitate bending of the contact surface upon contact with the inner surface of the shell half. Thereby fitting the curvature of the contact surface to the curvature of the shell half. The pressure load from the landing pad is thus evenly distributed over the contact surface which prevents breakage of the shell half.

In some embodiments, the local adjustment arrangement may comprise four surface plates positioned substantially parallel to each other. This provides the local adjustment arrangement with four second rotation axes, thereby obtaining great flexibility of the contact surface.

In an aspect of the lifting yoke, the lifting yoke may comprise a plurality of attachment units positioned along the longitudinal beam, each attachment unit comprises one or more connection elements for holding a first item, where the attachment units are configured for holding the first item on a first side of the longitudinal beam.

The first item may be an item to be mounted or a tool for performing a task on the inner surface of the shell half, such as a shear web or a lightning protection system or a gluing device or an abrading device. Structural elements such as a shear web are mounted and left in the shell half, and tools such as a gluing device or an abrading device are provided to the shell half and removed again after use.

The attachment units may be evenly distributed along the longitudinal beam, thereby obtaining an evenly distribution of connection elements along the first item. An advantage of this is that an equal hold is ensured along the entire item to be lifted by the lifting yoke.

The attachment units may further comprise two or more connection elements, wherein the connection elements may be arranged in a vertical row along the attachment unit. An advantage of this, is that each attachment unit obtains a stronger hold of the item to be lifted by the lifting yoke.

In some embodiments, attachment units comprise a first group of attachment units and a second group of attachment units, where the first group of attachment units are configured for holding a first item on the first side of the longitudinal beam, and the second group of attachment units are configured for holding a second item on a second side of the longitudinal beam. The lifting yoke can thus provide two items at the time to the shell half and thereby reduce the production time.

The second item may be identical to the first item, or the second item may be an item to be mounted or a tool for performing a task on the inner surface of the shell half, such as a shear web or a lightning protection system or a gluing device or an abrading device.

In some embodiments, the attachment units may be positioned so that the first group of attachment units and the second group of attachment units alternate along the longitudinal beam, thus ensuring an equal hold of and along the first and second item to be lifted by the lifting yoke.

The connection elements may be vacuum suction cups and/or mechanical grippers.

In some embodiments, the connection elements may be vacuum suction cups connected to one or more vacuum pumps for providing the vacuum at the suction cups. The one or more vacuum pumps may be positioned internally on the lifting yoke or externally from the lifting yoke. The one or more vacuum pumps in connection with the vacuum suction cups may be the same vacuum pumps, as the one or more vacuum pumps in connection with the landing pads.

An advantage of the one or more vacuum pumps, is that a continuous suction is provided at the connection elements, thereby ensuring a strong continuous adhesion to the first and/or second item.

The attachment units may further comprise clamps for holding a first item at small cross-sections of the first item. An advantage of this is that the hold of items with small cross-sections can be strengthened, thereby obtaining a better hold of the items.

The attachment units may comprise one or more horizontal movement actuators in connection with the connection elements configured for displacing the first item in a horizontal direction. Thus, when the lifting yoke is placed in the shell half, the items held by the lifting yoke can be adjusted in a horizontal direction to obtain a correct placement of the item on the inner surface of the shell half.

The horizontal movement actuators may be electric actuators or hydraulic actuators or pneumatic actuators or motor driven mechanisms.

The attachment units may comprise a vertical movement actuator configured for displacing the first item in a vertical direction. Thus, when the lifting yoke is placed in the shell half, the items held by the lifting yoke can be displaced in the vertical direction and placed on the inner surface of the shell half.

The vertical movement actuators may be electric actuators or hydraulic actuators or pneumatic actuators or motor driven mechanisms or chain hoists.

An advantage of the horizontal movement actuators and the vertical movement actuators is that each attachment unit becomes individually adjustable. Thereby, a correct placement and positioning of items on the inner surface of the first half can be obtained in a quick and easy way, which decreases the production time compared to conventional art.

As an example, the lifting yoke holding a gluing device is lifted into the shell half and placed on the inner surface, whereafter glue is disposed on the inner surface by the gluing device. The lifting yoke, still holding the gluing device, is lifted out of the shell half and the gluing device is detached from the lifting yoke. A first shear web is then attached to the first side of the lifting yoke with the first group of connection elements and a second shear web is attached to the second side of the lifting yoke with the second group of connection elements. The lifting yoke holding the first and second shear web is lifted into the shell half and placed on the inner surface. The position of each shear web is adjusted by horizontally displacing each shear web with the respective horizontal movement actuators, and when the correct position has been achieved, the two shear webs are placed in the glue disposed on the inner surface with the vertical movement actuators. The lifting yoke holds the two shear webs in place while the glue is curing, whereafter the two shear webs are detached from the lifting yoke, and the lifting yoke is lifted out of the shell half.

Thus, the lifting yoke according to embodiments of the invention can be utilized for multiple tasks in the wind turbine blade production, which reduces the amount of equipment needed at the production site and thus saves space at the production site. Furthermore, as the lifting yoke can place and position two items e.g. shear webs correctly in the shell half without the need of additional guiding and positioning equipment, the production time is significantly reduced compared to conventional art.

In an aspect of a lifting yoke, the lifting yoke may comprise one or more lifting points for engaging with one or more lifting devices.

In some embodiments, the lifting yoke may comprise two lifting points, thereby obtaining a stable lift of the lifting yoke with the lifting device.

In some embodiments, the lifting yoke may comprise one or more lifting plates, where one or more lifting plates comprises two or more lifting points. The lifting plates may be positioned on the longitudinal beam with an offset to accommodate change of the centre of gravity. Thereby obtaining a stable lift of the lifting yoke holding a load.

An advantage of this is that a stable lift may be obtained for a lifting yoke holding an uneven load.

In some embodiments the lifting device may be a crane, or other solutions known by the skilled person.

In an aspect of the lifting yoke, the lifting yoke may comprise one or more pipes extending vertically downwards from the longitudinal beam.

The pipes may be configured for engaging with one or more stands for holding the lifting yoke, when the lifting yoke is positioned outside of the shell half. Thereby, a stable hold of the lifting yoke is obtained, and the lifting yoke is prevented from falling on the side.

An aspect of embodiments of the invention is achieved by a preparation position for holding a lifting yoke. The preparation position comprises
one or more stands configured for holding the lifting yoke, and/or
a plurality of first item stands configured for holding a first item positioned along a first side of the one or more stands.

The preparation position for holding a lifting yoke may provide a designated location for storing the lifting yoke when the lifting yoke is not used and for preparing the lifting yoke for use.

An advantage of this is that the preparation position can be located away from the shell half so that the preparation and storing of the lifting yoke does not interfere with the production process of the wind turbine blade; or the preparation can be located nearby the shell half so that the lifting yoke is quick and easy to access and lift into the shell half. Thereby optimising the layout of the production site and saving space.

The one or more stands may provide a stable hold of the lifting yoke, preventing the lifting yoke from falling over during preparation procedures, such as attachment of items. An advantage of this is the prevention of tools and items such as shear webs breaking during the attachment procedure.

In some embodiments, the one or more stands may be configured to engage with one or more pipes extending vertically downwards from the longitudinal beam. Thereby obtaining a stable hold of the lifting yoke.

The one or more stands may be bolted to the flooring of the production site, preventing them from tipping, when the lifting yoke is placed in the stands.

The plurality of first items stands may provide a stable hold of the first item in a correct and stable position relative to the lifting yoke. Thereby, easing the attachment procedure and reducing the amount of horizontal correction needed by the horizontal movement actuators once the lifting yoke is place inside the shell half. Furthermore, the plurality of first item stands ensures correct longitudinal curvature of the items to be placed in the shell half, so that the longitudinal curvature the first item matches the longitudinal curvature of the inner surface of the shell half when placed on the inner surface. Thus, adding the smallest amount of pressure to the shell half, when placing the first item on the inner surface of the shell half, prevents breakage of the shell half.

The plurality of first item stands may be bolted to the floor of the production site, preventing them from tipping, when the first item is placed in the first item stands.

In some embodiments, the preparation position may further comprise a plurality of second item stands for holding a second item positioned substantially parallel to the one or more stands along a second side of the one or more stands. Thereby providing a stable hold of the second item in a correct and stable position relative to the lifting yoke.

An aspect of embodiments of the invention is achieved by a method for placing and positioning items on an inner surface of a shell half of a wind turbine blade. In embodiments, the method comprises steps of
providing a lifting yoke;
lifting the lifting yoke into the shell half;
placing the lifting yoke on the inner surface of the shell half;
performing a task on the inner surface of the shell half;
removing the lifting yoke from the shell half.

The step of providing a lifting yoke may be a step of providing a lifting yoke for placing and positioning items on an inner surface of a shell half, where the items may be items to be mounted or tools for performing a task on the inner surface.

The items to be placed on the inner surface of the shell half may be shear webs or a lightning protection system or a gluing device or an abrading device. Structural elements such as shear webs are mounted and left in the shell half, and tools such as a gluing device or an abrading device is provided to the shell half and removed again after use.

In some embodiments, the step of providing may include a step of arranging the lifting yoke in a preparation position, wherein a first item is positioned in a plurality of first item stands along a first side of the lifting yoke and/or a second item is positioned in a plurality of second item stands along a second side of the lifting yoke. The step of arranging may be followed by a step of attaching, wherein the first item and/or the second item may be attached to the first side and/or the second side of the lifting yoke.

The step of lifting may be a step of lifting the lifting yoke by a lifting device such as a crane or other solutions known by the skilled person.

The step of placing may be a step of placing the lifting yoke on the inner surface of the shell half, so that the lifting yoke stands on the inner surface. Thereby, the lifting yoke is placed on the inner surface without needing to hold or support the lifting yoke with a lifting device. The lifting device is therefor available for other tasks while the lifting yoke is operating in the shell half.

An advantage of this is that the production time of the wind turbine blade is optimized and the need for multiple lifting devices at the production site is eliminated, which increases the amount of free space at the production site.

The step of performing may be a step of performing a task on of the inner surface of the shell half such as mounting an item to or gluing or abrading the inner surface.

An advantage of this is that the same lifting yoke can be utilised for multiple tasks in the production of the wind turbine blade. Thereby reducing the amount of equipment needed for the production and saving space at production site.

The lifting yoke may be placed on the inner surface of the shell half during the entire timespan of the step of performing. This makes embodiments of the method of the present invention advantageous over conventional methods as the lifting device is available for other tasks while the lifting yoke is operating in the shell half, thereby freeing up space and saving space at the production site.

An advantage of this is that more and increasingly large wind turbine blades can be produced at the production sites.

In some embodiments, the step of performing may include a step of adjusting the position of the items attached to the lifting yoke by displacing the items horizontally with horizontal displacement means. A step of placing the items on the inner surface of the shell half may follow, wherein the items are displaced vertically with vertical displacement means. Thereby, a correct placement and positioning of items on the inner surface of the first half can be obtained in a quick and easy way.

An advantage of this is that the production time is reduced compared to conventional methods.

In some embodiments, items to be mounted on the inner surface of the shell half may be placed in glue disposed on the inner surface. In embodiments, the method may further comprise a step of waiting for a period of time after the step of performing. Thereby supporting the items and holding the items in place with the lifting yoke while the glue is curing.

For items to be left in the shell half, embodiments of the method may comprise a step of detaching the first item and/or the second from the lifting yoke, before the step of removing the lifting yoke form the shell half.

In some embodiments, the method further comprises a step of storing the lifting yoke at a preparation position after the step of removing.

The preparation position may be a preparation position for holding a lifting yoke. Thus, providing a designated location for storing the lifting yoke when the lifting yoke is not used and for preparing the lifting yoke for use.

An advantage of this is that the preparation position can be located away from the shell half so that the preparation and storing of the lifting yoke does not interfere with production process of the wind turbine blade; or the preparation can be located nearby the first half shell so that the lifting yoke is quick and easy to access and lift into the shell half. Thereby optimising the layout of the production site and saving space.

An aspect of embodiments of the invention is achieved by a method for placing and positioning webs on an inner surface of a shell half of a wind turbine blade. In embodiments, the method comprises steps of
providing a lifting yoke configured for holding a first web and/or a second web;
lifting the lifting yoke holding the first web and/or the second web into the shell half;
placing the lifting yoke on the inner surface of the shell half;
gluing the first web and/or the second web to the shell half;
detaching the first web and/or the second web from the lifting yoke;
removing the lifting yoke from the shell half.

The step of providing may be a step of providing a lifting yoke configured for holding a first web and/or a second web, where the first and second web may be shear webs such as a trailing shear web and/or a main shear web.

In some embodiments, the step of providing may include a step of arranging the lifting yoke in a preparation position, wherein a first web is positioned along a first side of the lifting yoke and/or a second web is positioned along a second side of the lifting yoke. The step of arranging may be followed by a step of attaching, wherein the first web and/or the second web may be attached to the first side and/or the second side of the lifting yoke.

The step of lifting may be a step of lifting the lifting yoke by a lifting device such as a crane or other solutions known by the skilled person.

The step of placing may be a step of placing the lifting yoke on the inner surface of the shell half, so that the lifting yoke stands on the inner surface. The lifting yoke is placed on the inner surface without needing to hold or support the lifting yoke with the lifting device. This makes embodiments of the method of the present invention advantageous over conventional methods as the lifting device is available for other tasks while the lifting yoke is operating in the shell half, thereby freeing up and saving space at the production site.

An advantage of this is that more and increasingly large wind turbine blades can be produced at the production sites.

The step of gluing may be a step of mounting the first web and/or second web on of the inner surface of the shell half by placing the first web and/or second web in glue disposed on the inner surface.

The lifting yoke may be placed on the inner surface of the shell half during the entire timespan of the step of gluing. An advantage of this is that the lifting device is available for other tasks while the lifting yoke is operating in the shell half, thereby freeing up space and saving space at the production site.

In some embodiments, the method may comprise a step of adjusting the position of the first web and/or the second web attached to the lifting yoke before the step of gluing. The step of adjusting may be a step of displacing the first web and/or the second web horizontally with horizontal displacement means.

In some embodiments, the step of gluing may include a step of placing the first web and/or the second web in the glue disposed on the inner surface of the shell half, wherein the first web and/or the second web are displaced vertically towards the shell half with vertical displacement means. Thereby, a correct placement and positioning of the first web and/or the second web on the inner surface of the first half can be obtained in a quick and easy way.

An advantage of this is that the production time is reduced compared to conventional methods.

In some embodiments, the step of gluing may be followed by a step of waiting for a period of time before detaching the first web and/or the second web from the lifting yoke. Thereby supporting the first web and/or the second web and holding the first web and/or the second web in place with the lifting yoke while the glue cures.

The first web and/or the second web are detached from the lifting yoke, before removing the lifting yoke form the shell half. Thereby leaving the first web and/or the second web mounted in the shell half.

In some embodiments, the method further comprises a step of storing the lifting yoke at a preparation position after the step of removing.

The preparation position may be a preparation position for holding a lifting yoke. Thus, providing a designated location for storing the lifting yoke, when the lifting yoke is not used, and for preparing the lifting yoke for use.

An advantage of this is that the preparation position can be located away from the shell half so that the preparation and storing of the lifting yoke does not interfere with production process of the wind turbine blade; or the preparation can be located nearby the first half shell so that the lifting yoke is quick and easy to access and lift into the shell half. Thereby optimising the layout of the production site and saving space.

### BRIEF DESCRIPTION

Some of the embodiments will be described in detail, with references to the following Figures, wherein like designations denote like members, wherein:

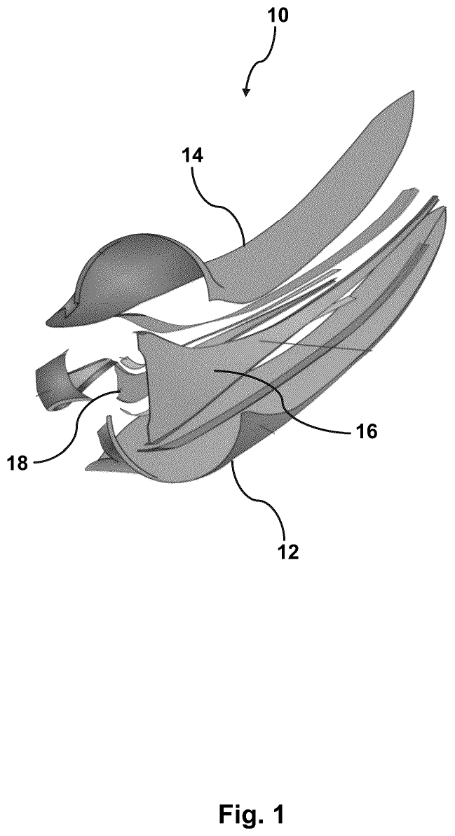

FIG. 1 depicts an exploded view of a wind turbine blade;

FIG. 2A depicts a lifting yoke according to an embodiment of the invention;

FIG. 2B depicts an exploded view of the lifting yoke according to FIG. 2A;

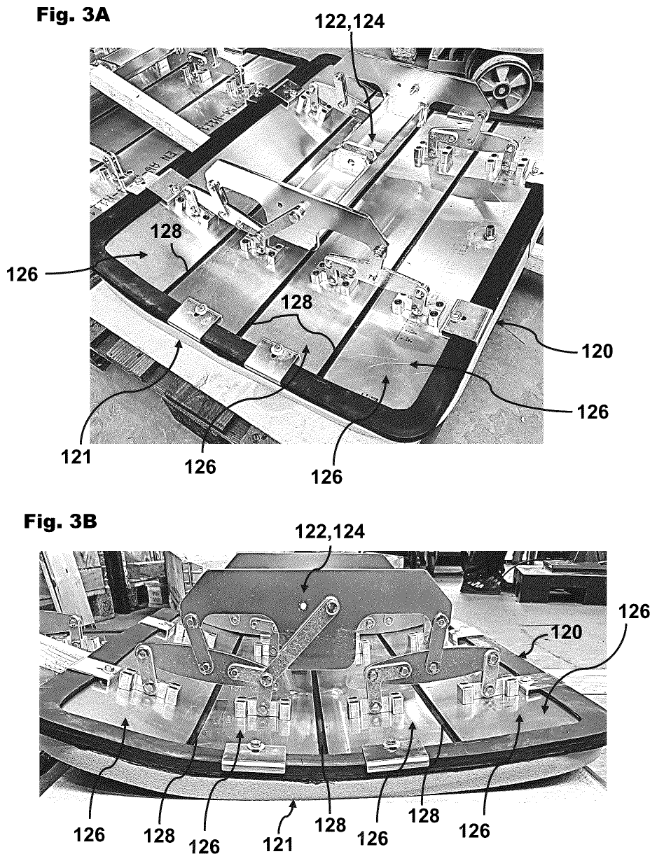

FIG. 3A depicts a landing pad according to an embodiment of the invention;

FIG. 3B depicts a side view of the landing pad according to FIG. 3A;

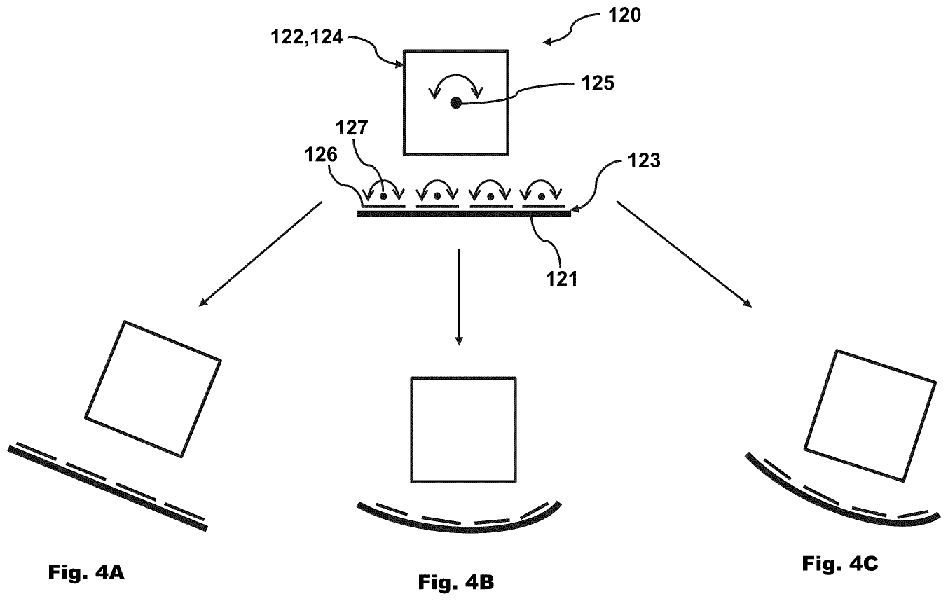

FIG. 4A depicts a global and local adjustment arrangement of a landing pad;

FIG. 4B depicts the local adjustment arrangement may pivot each surface plate about their respective second rotation axes;

FIG. 4C depicts the combinational effect of the global adjustment arrangement and the local adjustment arrangement;

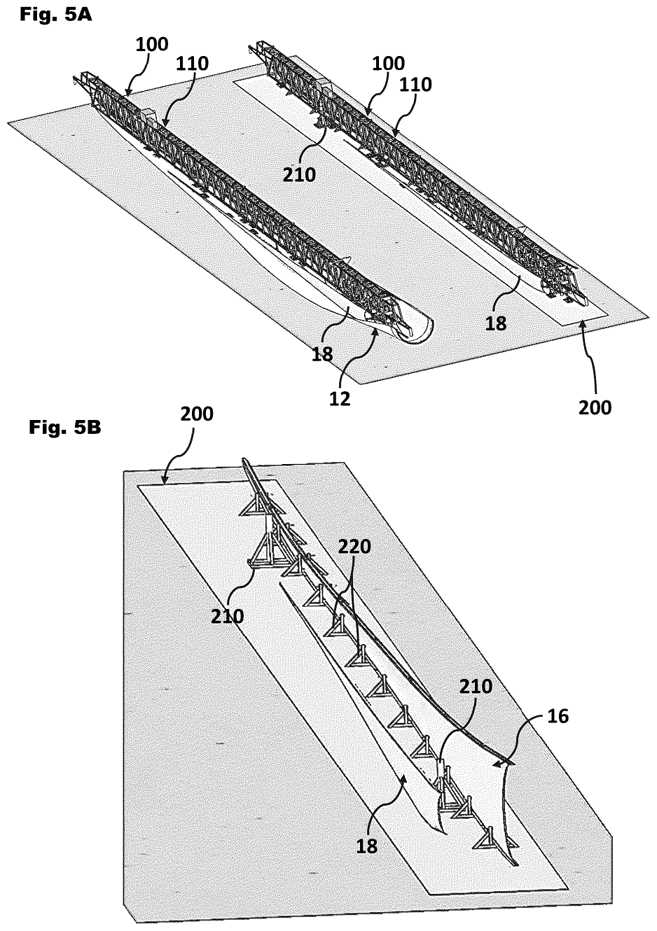

FIG. 5A depicts a lifting yoke in the preparation position and standing on the inner surface of a shell half of a wind turbine blade;

FIG. 5B depicts a preparation position;

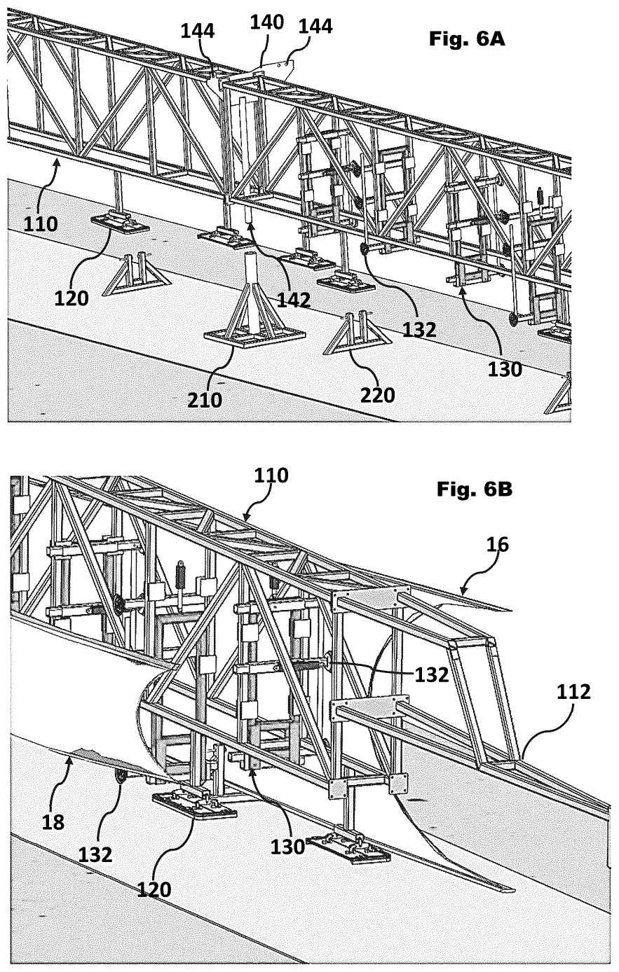

FIG. 6A depicts a lifting yoke in connection with two items;

FIG. 6B depicts a lifting yoke in connection with two items;

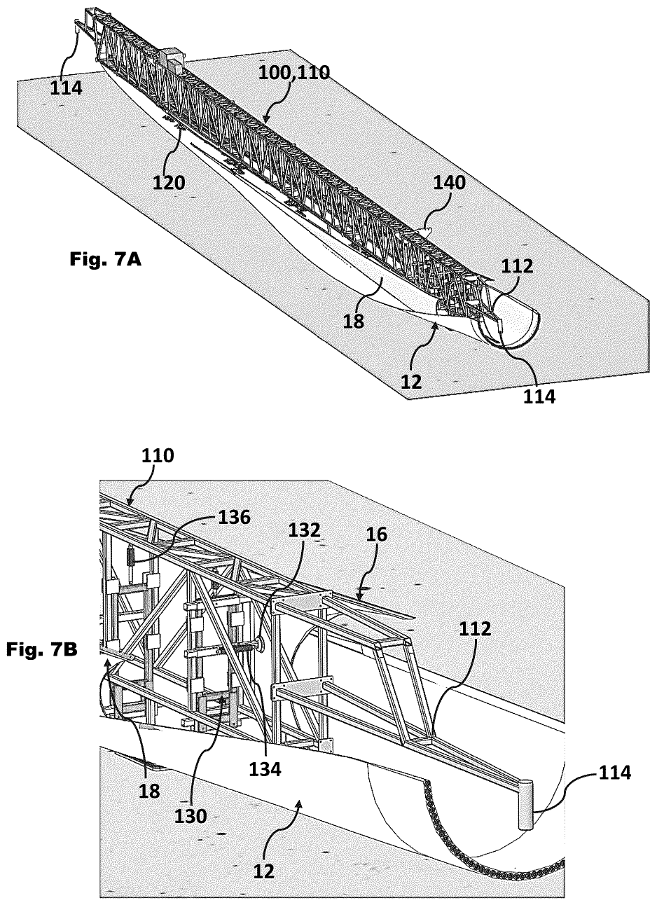

FIG. 7A depicts a lifting yoke according to an embodiment of the invention standing on the inner surface of a shell half of a wind turbine blade;

FIG. 7B depicts an exploded view of FIG. 7A of a lifting yoke according to an embodiment of the invention standing on the inner surface of a shell half of a wind turbine blade; and

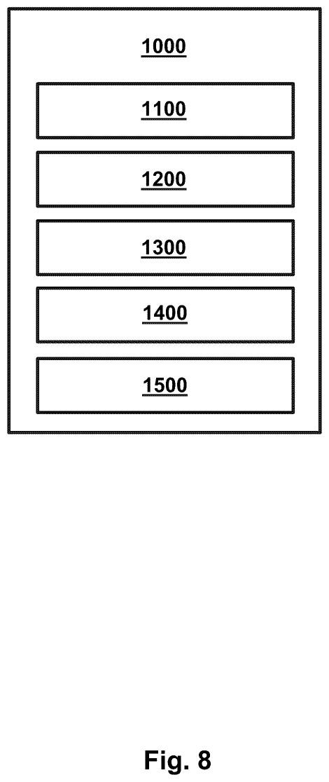

FIG. 8 depicts a method according to embodiments of the invention for placing and positioning items on an inner surface of a shell half of a wind turbine blade.

List of Reference Numbers

| | |
|---|---|
| Wind turbine blade | 10 |
| Shell half | 12 |
| Second shell half | 14 |
| First item | 16 |
| Second item | 18 |
| Lifting yoke | 100 |
| Longitudinal beam | 110 |
| Alignment shaft | 112 |
| Alignment pin | 114 |
| Landing pads | 120 |
| Contact surface | 121 |
| Global adjustment arrangement | 122 |
| Local adjustment arrangement | 123 |
| Arm | 124 |
| First rotation axis | 125 |
| Surface plates | 126 |
| Second rotation axis | 127 |
| Gaps | 128 |
| Attachment units | 130 |
| Connection elements | 132 |
| Horizontal movement actuators | 134 |
| Vertical movement actuator | 136 |
| Lifting plate | 140 |
| Pipes | 142 |
| Lifting point | 144 |
| Vacuum pump | 150 |
| Preparation position | 200 |
| Stand | 210 |
| First item stand | 220 |
| Method | 1000 |
| providing | 1100 |
| Lifting | 1200 |
| Placing | 1300 |
| Performing | 1400 |
| Removing | 1500 |

### DETAILED DESCRIPTION

FIG. 1 depicts an exploded view of a wind turbine blade 10 comprising a first shell half 12 and a second shell half 14. Between the first and the second shell half 12,14 the wind turbine blade 10 may further comprise a first item 16 and/or a second item 18. The first and second shell half 12,14 are named arbitrarily and could just as well be interchanged.

In some embodiments the first and/or second item 16,18 may be shear webs, such as a main shear web and a trailing shear, thereby adding stiffness, compressive strength, and limiting distortion of the structure from shear forces.

FIGS. 2A and B depict a lifting yoke 100 according to an embodiment of the invention, where FIG. 2A shows a lifting yoke 100 for placing and positioning items 16,18 on an inner surface of a shell half 12 of a wind turbine blade 10, where the items 16,18 may be items 16,18 to be mounted or tools for performing tasks on the inner surface of the shell half 12. The lifting yoke 100 is configured for standing on the inner surface of the shell half 12 during the entire timespan of the task performed in the shell half 12 without needing to hold or support the lifting yoke 100 with a lifting device. This makes the lifting yoke 100 of the embodiments of the present invention advantageous over conventional art lifting apparatuses and methods as the lifting device is available for other tasks while the lifting yoke 100 is operating in the shell half 12, thereby freeing up space and saving space at the production site.

The items 16,18 to be placed on the inner surface of the shell half 12 may be shear webs or a lightning protection system or a gluing device or an abrading device. In FIGS. 5 and 7, the shown items 16, 18 are shear web for illustrative purposes.

The lifting yoke 100 comprises a longitudinal beam 110 and may further comprise an alignment pin 114 in connection with an alignment shaft 112 positioned at each end of the longitudinal beam 110 to ensure correct placement of the lifting yoke 100 in the shell half 12.

A plurality of landing pads 120 is positioned along the longitudinal beam 110 and configured for standing on the inner surface of the shell half 12. The landing pads 120 may be adaptable to fit the contour of the inner surface of the shell half 12, thereby ensuring that the lifting yoke 100 stands stable on the inner surface without breaking the shell half 12.

The plurality of landing pads 120 may be evenly distributed along the bottom of the longitudinal beam 110 to ensure that the lifting yoke 100 stands stable on the inner surface of the shell half 12.

In some embodiments, the bottom of the longitudinal beam 110 may comprise a first side substantially parallel to a second side, where the plurality of landing pads 120 is arranged alternatingly at the first and second side of the longitudinal beam 110.

In other embodiments, the plurality of landing pads 120 may be positioned in a straight line along the bottom of the longitudinal beam 110.

The landing pads 120 may be suction pads that are configured for gripping the inner surface of the shell half 12, thereby securing and stabilizing the lifting yoke 100 in the shell half 12.

The landing pads 120 may be connected to one or more vacuum pumps 150 for providing the vacuum at the landing pads 120. The one or more vacuum pumps 150 may be positioned internally on the lifting yoke 100 or externally to the lifting yoke 100. In the embodiment shown in FIG. 2A a vacuum pump 150 for providing suction to the landing pads 120 is positioned internally on the lifting yoke 100 on top of the longitudinal beam 110.

FIG. 2B depicts an enlarged view of a section of the lifting yoke 100, where the lifting yoke 100 may comprise a plurality of attachment units 130 positioned along the longitudinal beam 110. Each attachment unit 130 comprises one or more connection elements 132 for holding a first item 16, and the attachment units 130 are configured for holding the first item 16 on a first side of the longitudinal beam 110.

The first item 16 may be an item to be mounted or a tool for performing a task on the inner surface of the shell half 12, such as a shear web or a lightning protection device or a gluing device or an abrading device.

The attachment units 130 may be evenly distributed along the longitudinal beam, thereby obtaining an even distribution of connection elements 132 along the item 16.

The attachment units 130 may further comprise two or more connection elements 132 arranged in a vertical row along the attachment unit 130.

In some embodiments, attachment units 130 comprise of a first group of attachment units 130 and a second group of attachment units 130, where the first group of attachment units 130 are configured for holding a first item 16 on the first side of the longitudinal beam 110, and the second group of attachment units 130 are configured for holding a second item 18 on a second side of the longitudinal beam 110. The lifting yoke 100 can thus lift two items 16,18 at the same time.

The second item 18 may be identical to the first item 16, or the second item 18 may be an item to be mounted or a tool for performing a task on the inner surface of the shell half 12, such as a shear web or a lightning protection system or a gluing device or an abrading device.

In some embodiments, the attachment units 130 may be positioned so that the first group of attachment units 130 and the second group of attachment units 130 alternate along the longitudinal beam 110, thus ensuring an equal hold of and along the first and second item 16,18 to be lifted by the lifting yoke 110.

The connection elements 132 may be vacuum suction cups and/or mechanical grippers.

In some embodiments, the connection elements 132 may be vacuum suction cups connected to one or more vacuum pumps 150 for providing the vacuum at the suction cups. The one or more vacuum pumps 150 may be positioned internally on the lifting yoke 100 or externally to the lifting yoke 100. The one or more vacuum pumps 150 in connection with the vacuum suction cups may be the same vacuum pumps 150, as the one or more vacuum pumps 150 in connection with the landing pads 120.

The attachment units 130 may further comprise clamps for holding a first item 16 and/or a second item 18 at small cross-sections of the first and/or second item 16,18.

The attachment units 130 may comprise one or more horizontal movement actuators 134 in connection with the connection elements 132 configured for displacing the first item 16 and/or second item 18 in a horizontal direction. Thus, when the lifting yoke 100 is placed in the shell half 12, the items 16,18 held by the lifting yoke 100 can be adjusted in a horizontal direction to obtain a correct placement of the items 16,18 on the inner surface of the shell half 12.

The horizontal movement actuators 134 may be electric actuators or hydraulic actuators or pneumatic actuators or motor driven mechanisms.

The attachment units 130 may comprise a vertical movement actuator 136 configured for displacing the first item 16 and/or second item 18 in a vertical direction. Thus, when the lifting yoke 100 is placed in the shell half 12, the items 16,18 held by the lifting yoke 100 can be displaced in the vertical direction and placed on the inner surface of the shell half 12.

The vertical movement actuators 136 may be electric actuators or hydraulic actuators or pneumatic actuators or motor driven mechanisms or chain hoists.

FIG. 3A depicts a top view and 3B depicts a front view of a landing pad 120 according to an embodiment of the invention. A global adjustment arrangement 122 for pivoting the landing pad 120 comprise an arm 124 defining a first rotation axis 125. The arm 124 is in pivotable connection with the landing pad 120 around the first rotation axis 125. Thereby, pivoting the landing pad 120 to fit the contour of the inner surface of the shell half 12.

In some embodiments, the arm 124 may be a horizontal arm defining a first rotation axis 125 that is substantially parallel to the longitudinal beam 110.

The landing pads 120 comprises a contact surface 121 for being in contact with the inner surface of the shell half 12.

The contact surface 121 may be a flexible non-slip surface for securing the lifting yoke 100 on the inner surface and ensuring that pressure load from the landing pad 120 is evenly distributed over the contact surface 121, thus preventing the shell half 12 from breaking.

In some embodiments, the contact surface 121 may be a rubber membrane.

The landing pads 120 further comprises a local adjustment arrangement 123 configured for adjusting a curvature of the contact surface 121 to the curvature of the inner surface of the shell half 12. The local adjustment arrangement 123 may comprise two or more surface plates 126. The two or more surface plates 126 each comprise second rotation axis 127 that is substantially parallel to the first rotation axis 125 of the global adjustment system 122.

The local adjustment arrangement 123 may further comprise gaps 128 positioned between the two or more surface plates 126. The two or more surface plates 126 may be configured for pivoting around the second rotation axes 127, while the gaps 128 provide space for the surface plates 126 to pivot relative to each other, so that the local adjustment arrangement 123 can adapt to the curvature of the inner surface of the shell half 12.

The local adjustment unit 123 can thus facilitate bending of the contact surface 121 upon contact with the inner surface of the shell half 12. Thereby fitting the curvature of the contact surface 121 to the curvature of the shell half 12 and distributing the pressure load from the landing pad 120 evenly over the contact surface 121 which prevents breakage of the shell half 12.

In some embodiments, the local adjustment arrangement 123 may comprise four surface plates 126 positioned substantially parallel to each other. This provides the local adjustment arrangement 123 with four second rotation axes 127, thereby obtaining great flexibility of the contact surface 121.

With the global adjustment arrangement 122 and the local adjustment arrangement 123, the individual landing pad 120 can be adjusted to accommodate the contour and the curvature of the inner surface of the shell half 12. Thereby preventing the shell half 12 from breaking due to an unnatural pressure on the shell half 12.

FIGS. 4A, 4B and 4C depicts a global and local adjustment arrangement 122,123 of a landing pad 120 illustrating the different adjustment possibilities. The global adjustment arrangement 122 and the local adjustment arrangement 123 are identical to those depicted in FIG. 3A.

The global adjustment arrangement 122 may comprise an arm 124 that is in pivotable connection with the landing pad 120. The arm 124 may define a first rotation axis 125 about which the landing pad 120 can be pivoted.

The local adjustment arrangement 123 may comprise two or more surface plates 126 that each may comprise a second rotation axis 127 that is substantially parallel to the first rotation axis 125 of the global adjustment system 122. The two or more surface plates 126 may be configured for pivoting around the second rotation axes 127. The local adjustment arrangement 123 may further comprise gaps 128 positioned between the two or more surface plates 126. The gaps 128 provide space for the surface plates 126 to pivot relative to each other.

Thus, the global adjustment arrangement 122 enables tilting of the landing pad 120, and the local adjustment arrangement 123 enable bending of the contact surface 121.

As depicted in FIGS. 4A and 4C, the global adjustment arrangement 122 may pivot the landing pad 120 about the first rotation axis 125, so that the tilt of the landing pad 120 matches the contour of the inner surface of the shell half 12.

As depicted in FIGS. 4B and 4C, the local adjustment arrangement 123 may pivot each surface plate 126 about their respective second rotation axes 127, so that the curvature of the contact surface 121 matches the curvature of the inner surface of the shell half 12.

FIG. 4C depicts the combinational effect of the global adjustment arrangement 122 and the local adjustment arrangement 123, where the landing pad 120 matches the contour of the inner surface of the shell half 12 and the contact surface 121 matches the curvature of the inner surface of a shell half 12.

FIGS. 5A and B depict in FIG. 5A a lifting yoke 100 in the preparation position 200 and standing on the inner surface of a shell half 12 of a wind turbine blade 10, and in FIG. 5B a preparation position 200.

The lifting yoke 100 depicted in FIG. 5A is identical to the lifting yoke 100 depicted in FIGS. 2A and 2B to FIGS. 4A, 4B and 4C.

Referring to FIGS. 5A and 5B, the preparation position 200 for holding a lifting yoke 100 may provide a designated location for storing the lifting yoke 100, when the lifting yoke 100 is not used, and for preparing the lifting yoke 100 for use. Thus, the preparation position 200 can be located away from the shell half 12 so that the preparation and storing of the lifting yoke 100 does not interfere with production process of the wind turbine blade 10; or the preparation position 200 can be located near the first half shell 12 so that the lifting yoke 100 is quick and easy to access and lift into the shell half 12. Thereby optimising the layout of the production site and saving space.

The preparation position 200 may comprise one or more stands 210 configured for holding the lifting yoke 100, which may provide a stable hold of the lifting yoke 100, preventing the lifting yoke 100 from falling over during preparation procedures, such as attachment of items 16,18.

In some embodiments, the one or more stands 210 may be configured for engaging with one or more pipes 142 that may extend vertically downwards from the longitudinal beam 110.

The one or more stands 210 may be bolted to the flooring of the production site, preventing them from tipping, when the lifting yoke 100 is placed in the stands 210.

The preparation position 200 may further comprise a plurality of first item stands 220 configured for holding a first item 16 positioned along a first side of the one or more stands 210.

The plurality of first items stands 220 may provide a stable hold of the first item 16 in a correct and stable position relative to the lifting yoke 100. Thereby, easing the attachment procedure and reducing the amount of horizontal correction needed by the horizontal movement actuators 134 once the lifting yoke 100 is place inside the shell half 12. Furthermore, the plurality of first item stands 220 ensures correct longitudinal curvature of the items 16,18 to be placed in the shell half 12, so that the longitudinal curvature the first item 16 matches the longitudinal curvature of the inner surface of the shell half 12 when placed on the inner surface. Thus, adding the smallest amount of pressure to the shell half 12, when placing the first item 16 on the inner surface, preventing breakage of the shell half 12.

The plurality of first item stands 220 may be bolted to the flooring of the production site, preventing them from tipping, when the first item 16 is placed in the first item stands 220.

In some embodiments, the preparation position 200 may further comprise a plurality of second item stands for holding a second item 18 positioned substantially parallel to the one or more stands 210 along a second side of the one or more stands 210. Thereby providing a stable hold of the second item 18 in a correct and stable position relative to the lifting yoke 100.

FIGS. 6A and B depict in FIG. 6A a lifting yoke 100 being placed in the preparation position 200, and in FIG. 6B a lifting yoke 100 in connection with two items 16, 18. The lifting yoke 100 illustrated in FIGS. 6A and 6B is identical to the lifting illustrated in FIGS. 2A and 2B to FIGS. 4A, 4B and 4C, and the preparation position 200 is identical to the preparation position 200 illustrated in FIGS. 5A and 5B.

The lifting yoke 100 may comprise one or more pipes 142 extending vertically downwards from the longitudinal beam 110. The pipes 142 may be configured for being inserted into the one or more stands 210 comprised in the preparation position 200, when the lifting yoke 100 is placed at the preparation position 200. Thereby obtaining a stable hold of the lifting yoke 100.

The lifting yoke 100 may comprise one or more lifting points 144 for engaging with one or more lifting devices (not shown).

In some embodiments the lifting yoke 100 may be lifted by a lifting device such as a crane or other solutions known by the skilled person.

In some embodiments, the lifting yoke 100 may comprise two lifting points 144, thereby obtaining a stable lift of the lifting yoke 100 with the lifting device.

In some embodiments, the lifting yoke 100 may comprise one or more lifting plates 140, where the one or more lifting plates 140 comprises two or more lifting points 144. The lifting plates 140 may be positioned with an offset on the longitudinal beam 110 to accommodate change of the centre of gravity. Thereby obtaining a stable lift of the lifting yoke, when holding an uneven load, such as only lifting a first time 16 or lifting a larger first item 16 and a smaller second item 18.

FIGS. 7A and 7B depicts a lifting yoke 100 according to an embodiment of the invention standing on the inner surface of a shell half 12 of a wind turbine blade 10. The lifting yoke 100 illustrated in FIGS. 7A and 7B is identical to the lifting illustrated in FIGS. 2A and B to FIGS. 6A and 6B.

FIG. 8 depicts the method 1000 according to the invention for placing and positioning items 16,18 on an inner surface of a shell half 12 of a wind turbine blade 10.

In embodiments, the method 1000 comprises a step of providing 1100 a lifting yoke 100, where the step of providing 1100 may be a step of providing 1100 a lifting yoke 100 for placing and positioning items 16,18 on an inner surface of a shell half 12, where the items 16,18 may be items 16,18 to be mounted or tools for performing a task on the inner surface.

The items 16,18 may be shear webs or a lightning protection device or a gluing device or an abrading device.

The step of providing 1100 is followed by a step of lifting 1200 the lifting yoke 100 into the shell half 12, where the lifting yoke 100 may be lifted by a lifting device such as a crane or other solutions known by the skilled person.

After the lifting yoke 100 has been lifted into the shell half 12, the lifting yoke 100 is place on the inner surface of the shell half 12 during the step of placing 1300. The lifting yoke 100 may be placed so that the lifting yoke 100 stands on the inner surface. Thereby, there is no need for holding or supporting the lifting yoke 100 with a lifting device. Thus, while the lifting yoke 100 is operating in the shell half 12 the lifting device is available for other tasks.

The step of placing 1300 is followed by a step of performing 1400 a task on the inner surface of the shell half 12. The task may be mounting a first and/or a second item 16,18 to the inner surface or gluing or abrading the inner surface.

The lifting yoke 100 may be placed on the inner surface of the shell half 12 during the entire timespan of the step of performing 1400. This makes the method 1000 of embodiments of the present invention advantageous over conventional methods as the lifting device is available for other tasks while the lifting yoke 100 is operating in the shell half 12, thereby freeing up space and saving space at the production site.

A step of removing 1500 follows the step of performing 1400, wherein the lifting yoke 100 is removed from the shell half 12.

In some embodiments, the method further comprises a step of storing the lifting yoke at a preparation position 200 after the step of removing 1500.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A lifting yoke for placing and positioning items on an inner surface of a shell half of a wind turbine blade, the lifting yoke comprises:
a longitudinal beam,
a plurality of landing pads positioned along the longitudinal beam configured for standing on the inner surface of the shell half,
a plurality of global adjustment arrangements for pivoting the plurality of landing pads, wherein the landing pads include
a contact surface for being in contact with the inner surface, and
a local adjustment arrangement for adjusting a curvature of the contact surface to the curvature of the inner surface.

2. A lifting yoke according to claim 1, wherein the landing pads are suction pads.

3. A lifting yoke according to claim 1, wherein the global adjustment arrangements comprise an arm defining a first rotation axis, where the arm is in pivotable connection with the landing pad around the first rotation axis.

4. A lifting yoke according to claim 1, wherein the local adjustment arrangements comprising:
two or more surface plates, and
gaps positioned between the two or more surface plates,
where the two or more surface plates are configured for bending the contact surface.

5. A lifting yoke according to claim 1, wherein the lifting yoke comprises a plurality of attachment units positioned along the longitudinal beam, each attachment unit comprises one or more connection elements for holding a first item, where the attachment units are configured for holding the first item on a first side of the longitudinal beam.

6. A lifting yoke according to claim 1, wherein the lifting yoke comprises one or more lifting points for engaging with one or more lifting devices.

7. A lifting yoke according to claim 1, wherein the lifting yoke comprise one or more pipes extending vertically downwards from the longitudinal beam.

8. A preparation position for holding a lifting yoke according to claim 1, the preparation position comprises:
one or more stands configured for holding the lifting yoke, and/or
a plurality of first item stands configured for holding a first item positioned along a first side of the one or more stands.

9. A method for placing and positioning items on an inner surface of a shell half of a wind turbine blade, the method comprises:
providing a lifting yoke;
lifting the lifting yoke into the shell half;
placing the lifting yoke on the inner surface of the shell half;
performing a task on the inner surface of the shell half; and
removing the web lifting yoke from the shell half.

10. A method for placing and positioning webs on an inner surface of a shell half of a wind turbine blade, the method comprises:
providing a lifting yoke configured for holding a first web and/or a second web;
lifting the lifting yoke holding the first web and/or the second web into the shell half;
placing the lifting yoke on the inner surface of the shell half;
gluing the first web and/or the second web to the shell half;
detaching the first web and/or the second web from the lifting yoke; and
removing the lifting yoke from the shell half.
